(19) United States
(12) Patent Application Publication
(10) Pub. No.: US 2007/0258198 A1
(43) Pub. Date: Nov. 8, 2007

(54) Electronic apparatus

(76) Inventors: Hiroyuki Minaguchi, Hagashimatsuyama-shi (JP); Yasuyuki Horii, Tokyo (JP); Shinji Hiratomo, Tokyo (JP)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/495,085

(22) Filed: Jul. 28, 2006

(30) Foreign Application Priority Data
Jul. 29, 2005 (JP) P2005-220301

(51) Int. Cl. G06F 1/16

(52) U.S. Cl. 361/681

(57) ABSTRACT

According to one embodiment, an electronic apparatus that includes: a housing having a wall having an opening; a display which is disposed in the housing, opposed to the opening, and having a screen; a panel having a transparency and disposed in the housing between the opening and the screen of the display; and a fixing member which fixes the panel to the display, one end of the fixing member being bonded to the display and the other end of the fixing member being bonded to the panel.

### CROSS-REFERENCE TO RELATED APPLICATIONS

This application is based upon and claims the benefit of priority from Japanese Patent Application No. 2005-220301, filed Jul. 29, 2005, the entire contents of which are incorporated herein by reference.

### BACKGROUND

1. Field

One embodiment of the invention relates to an electronic apparatus in which a panel such as a filter is disposed in front of a display. In particular, the invention relates to a fixing structure for fixing the panel to the display.

2. Description of the Related Art

Electronic apparatus such as portable computers are equipped with a display unit having a housing. The housing has a front wall having an opening, and accommodates a display such as an LCD (liquid crystal display) inside. The display has a screen. The display area is opposed to the opening of the housing.

The housing also accommodates a panel such as a filter or a tablet between the opening and the display area of the display. Since the panel is made of a transparent material, the display area of the display can be seen from outside the housing through the opening and the panel.

It is disclosed by, for example, Japanese Patent Application Publication (KOKAI) No. 2000-276254, as a structure for accommodating such a panel, a structure in which a tablet is disposed in a housing by using a double-sided adhesive tape. In the electronic apparatus disclosed in JP-A-2000-276254, the tablet and a display are disposed in the housing independently of each other. The tablet is fixed directly to the back surface of a top case of a display unit and the screen of the display with a double-sided adhesive tape.

Where the tablet and the display are disposed in the housing independently of each other in the above-described manner, the tablet and the display need to be attached or detached sequentially in assembling or disassembling the display unit. That is, this structure has room for improvement in terms of the ease of assembling and maintenance/replacement of the display unit. In view of this, it is disclosed by, for example, Japanese Patent Application Publication (KOKAI) No. 2004-12617, a structure in which a display and a tablet are disposed in a housing in a state that the former are held together.

The electronic apparatus disclosed in JP-A-2004-12617 is equipped with a holding member having first and second holding portions. The first holding portion assumes such a frame shape as to surround the entire peripheral portion of the display and holds the display. The second holding portion assumes such a frame shape as to surround the entire peripheral portion of the tablet and holds the tablet.

For example, in each of the first and second holding portions of JP-A-2004-12617, the whole of the member constituting the frame is an integral member and has a bracket-shaped cross section. Therefore, to cause the display to be held by the first holding portion, it is necessary to lift the peripheral portion of the frame and insert the display into the first holding portion. The same is true of a case of causing the tablet to be held by the second holding portion.

As described above, to cause the display, for example, to be held by the holding member, it is necessary to perform, at the same time, an operation of lifting the peripheral portion of the frame and an operation of inserting the display, for example, into the holding portion. This structure has room for improvement in terms of the ease of assembling of the display unit.

One embodiment of the invention provides an electronic apparatus which is increased in the ease of assembling of a display unit.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view of a portable computer according to a first embodiment of the invention;

FIG. 2 is an exemplary exploded perspective view of a display unit according to the first embodiment;

FIG. 3 is an exemplary exploded perspective view of a liquid crystal display module according to the first embodiment;

FIG. 4 is an exemplary sectional view of the display unit taken along line A-A in FIG. 1 according to the first embodiment;

FIG. 5 is an exemplary perspective view of a bottom fixing member in a certain stage of its manufacture according to the first embodiment;

FIG. 6 is an exemplary perspective view of the bottom fixing member in a state in use according to the first embodiment;

FIG. 7 is an exemplary sectional view of a display unit according to a modification of the first embodiment;

FIG. 8 is an exemplary perspective view of a liquid crystal display module according to a second embodiment of the invention;

FIG. 9 is an exemplary sectional view of a display unit according to the second embodiment;

FIG. 10 is an exemplary perspective view of a liquid crystal display module according to a third embodiment of the invention;

FIG. 11 is an exemplary sectional view of a display unit according to the third embodiment;

FIG. 12 is an exemplary sectional view of a display unit according to a modification of the third embodiment;

FIG. 13 is an exemplary sectional view of a display unit according to a modification of the first embodiment;

FIG. 14 is an exemplary sectional view of a display unit according to a modification of the second embodiment;

FIG. 15 is an exemplary sectional view of a display unit according to a modification of the third embodiment;

FIG. 16 is an exemplary perspective view of a liquid crystal display module according to a modification of the first embodiment;

FIG. 17 is an exemplary perspective view of a liquid crystal display module according to another modification of the first embodiment;

FIG. 18 is an exemplary perspective view of a liquid crystal display module according to a modification of the second embodiment;

FIG. 19 is an exemplary perspective view of a liquid crystal display module according to a fourth embodiment of the invention;

FIG. 20 is an exemplary perspective view of a liquid crystal display module according to a modification of the fourth embodiment;

FIG. 21 is an exemplary sectional view of a display unit according to a fifth embodiment of the invention;

FIG. 22 is an exemplary sectional view of a display unit according to a modification of the fifth embodiment;

FIG. 23 is an exemplary exploded perspective view of a liquid crystal display module according to a sixth embodiment of the invention; and

FIG. 24 is an exemplary side view, as viewed from direction B, of the liquid crystal display module of FIG. 23 according to the sixth embodiment.

### DETAILED DESCRIPTION

Various embodiments according to the invention will be described hereinafter with reference to the accompanying drawings. In general, according to one embodiment of the invention, an electronic apparatus includes: a housing having a wall having an opening; a display which is disposed in the housing, opposed to the opening, and having a screen; a panel having a transparency and disposed in the housing between the opening and the screen of the display; and a fixing member which fixes the panel to the display, one end of the fixing member being bonded to the display and the other end of the fixing member being bonded to the panel.

Portable computers according to embodiments of the present invention will be hereinafter described with reference to the drawings.

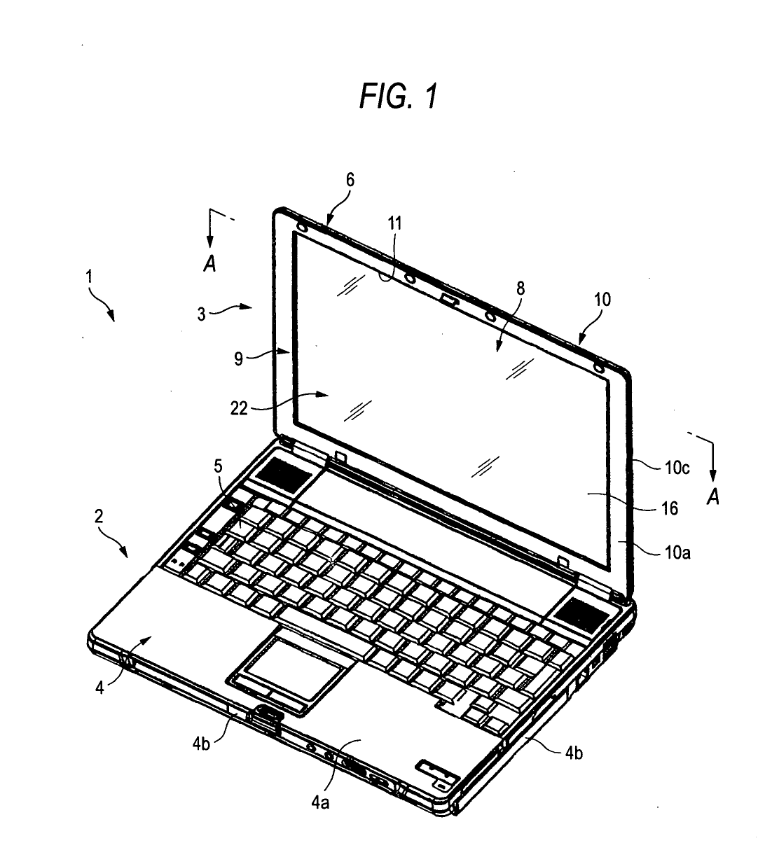

FIGS. 1 to 7 show a portable computer as an electronic apparatus according to a first embodiment of the invention. As shown in FIG. 1, a portable computer 1 is equipped with a main body 2 and a display unit 3.

The main body 2 is equipped with a box-shaped main body case 4. The main body case 4 has a top wall 4a, a circumferential wall 4b, and a bottom wall (not shown). The top wall 4a of the main body case 4 supports a keyboard 5.

As shown in FIG. 1, the display unit 3 is supported by a rear end portion of the main body case 4 via a hinge device (not shown). Therefore, the display unit 3 can be swung between a closed position where it is laid down so as to cover the top wall 4a of the main body case 4 from above and an open position where it erects so as to expose the top wall 4a.

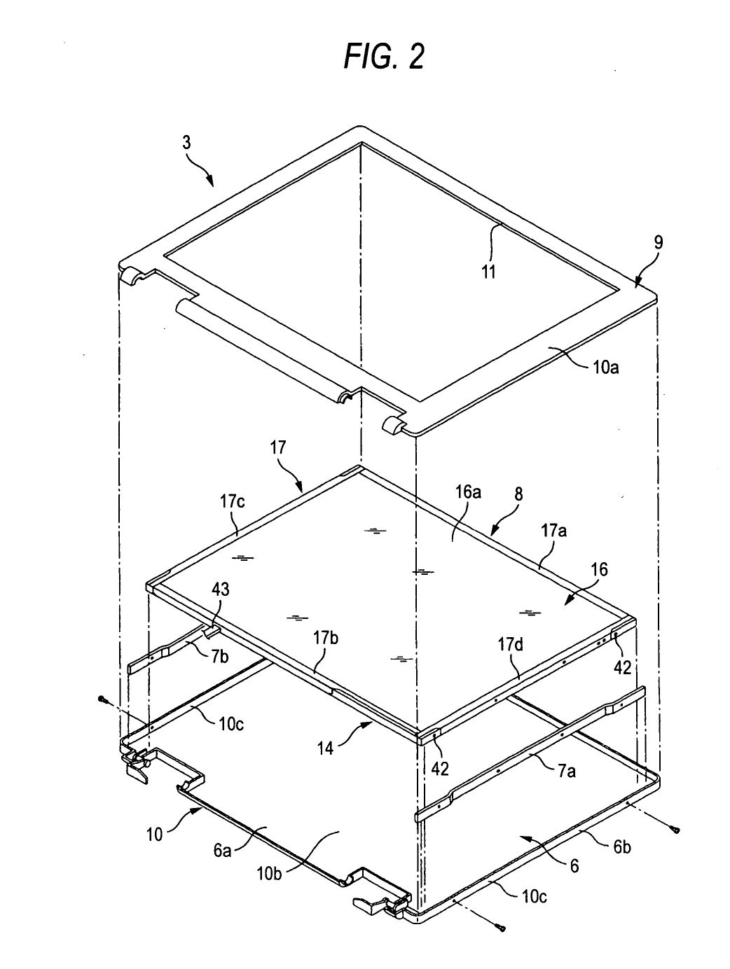

As shown in FIG. 2, the display unit 3 is equipped with a housing base 6, a pair of fixing metal parts 7a and 7b, a liquid crystal display module 8, and a housing cover 9. The housing base 6 has a bottom wall 6a and a circumferential wall 6b which erects from the circumference of the bottom wall 6a.

The liquid crystal display module 8 is attached to the housing base 6 via the fixing metal parts 7a and 7b. The housing cover 9 is attached to the housing base 6 in such a manner that the liquid crystal display module 8 is sandwiched between them. Au such, the housing base 6 and the housing cover 9 together constitute a housing 10 which accommodates the liquid crystal display module 8. In other words, the housing cover 9 serves as a front wall 10a of the housing 10 and the bottom wall 6a and the circumferential wall 6b of the housing base 6 serve as a rear wall 10b and a side wall 10c, respectively, of the housing 10.

A front wall 10a of the housing 10 has an opening 11. As shown in FIG. 1, the liquid crystal display module 8 is exposed to the outside of the housing 10 through the opening 11.

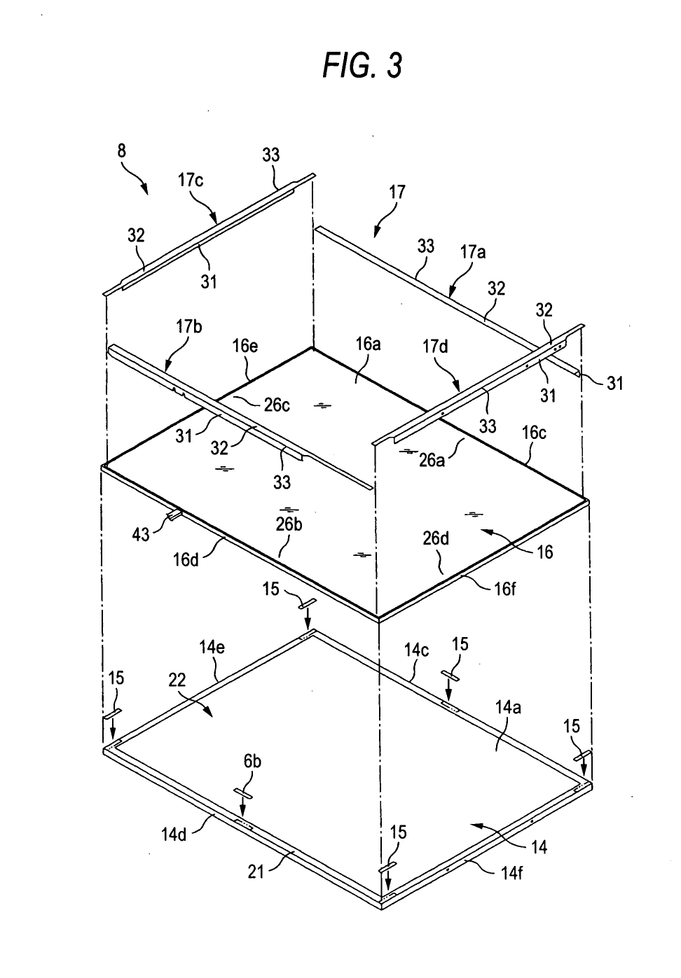

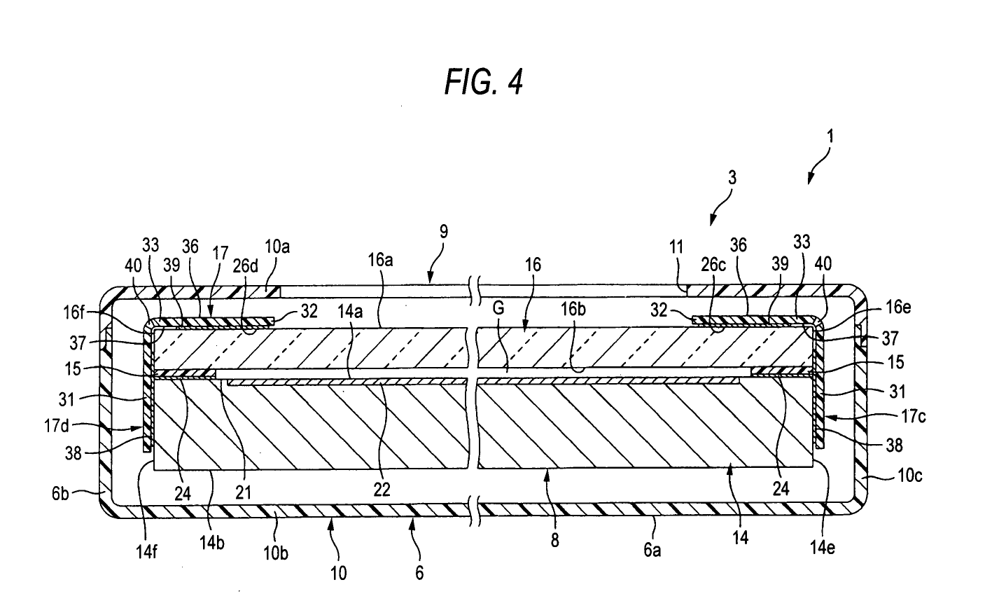

As shown in FIG. 3, the liquid crystal display module 8 is equipped with a liquid crystal display 14 (hereinafter abbreviated as “LCD 14”), six spacers 15, a filter 16 as a panel, and fixing members 17. FIG. 4 is a sectional view of the display unit 3. Although each fixing member 17 has cuts (see FIG. 3), FIG. 4 is a schematic drawing in which the cuts of the fixing members 17 are omitted for convenience of description.

The LCD 14 assumes a plate shape and has a front surface 14a, a back surface 14b, a top side surface 14c, a bottom side surface 14d, a left side surface 14e, and a right side surface 14f. As shown in FIG. 4, the front surface 14a of the LCD 14 is an example of the screen and is opposed to the opening 11 of the housing 10. Almost the entire area of the front surface 14a, excluding a peripheral portion 21, of the LCD 14 is a display area 22. The back surface 14b of the LCD 14 is opposed to the rear wall lob of the housing 10. The back surface 14b of the LCD 14 is mounted with circuit boards and electronic components for controlling the LCD 14 and the filter 16 (both not shown).

The top side surface 14c, the bottom side surface 14d, the left side surface 14e, and the right side surface 14f of the LCD 14 extend so as to connect the circumference of the front surface 14a and that of the back surface 14b. That is, the top side surface 14c, the bottom side surface 14d, the left side surface 14e, and the right side surface 14f extend from the circumference of the front surface 14a toward the side opposite to the front wall 10a of the housing 10.

The LCD 14 is an example of the display. The display is not limited to the LCD 14 and may be of any type; it may be a plasma display or an organic EL display.

As shown in FIG. 3, the six spacers 15 are attached to the peripheral portion 21 of the front surface 14a of the LCD 14. More specifically, the six spacers 15 are distributed so as to be located at the four corners of the LCD 14 and at the centers of those parts of the LCD 14 which extend in its longitudinal direction. As shown in FIG. 4, the filter 16 is disposed in front of the spacers 15. Sandwiched between the LCD 14 and the filter 16, the spacers 15 form a gap G between them. Although in this embodiment the spacers 15 are fixed to the LCD 14 with adhesives 24, the method for fixing the spacers 15 is not limited to gluing. The spacers 15 may be made of any kind of material; they may be made of a resin, rubber, or a metal.

As shown in FIG. 4, the filter 16 is disposed between the opening 11 of the housing 10 and the front surface 14a of the LCD 14. The filter 16 has a filter back surface 16b as one panel surface, a filter front surface 16a as the other panel surface, and a filter top side surface 16c, a filter bottom side surface 16d, a filter left side surface 16e, and a filter right side surface 16f as panel side surfaces.

The filter front surface 16a is opposed to the opening 11 of the housing 10. The filter back surface 16b is opposed to the front surface 14a of the LCD 14 and is in contact with the spacers 15. The filter top side surface 16c, the filter bottom side surface 16d, the filter left side surface 16e, and the filter right side surface 16f extend so as to connect the circumference of the filter front surface 16a and that of the filter back surface 16b. That is, the filter bottom side surface 16d, the filter left side surface 16e, and the filter right side surface 16f extend from the circumference of the filter back surface 16b toward the front wall 10a of the housing 10.

The filter front surface 16a has a top end portion 26a as one end of the filter 16 and a bottom end portion 26b as the other end of the filter 16. The top end portion 26a is that portion of the front surface 16a which is close to the filter top side surface 16c. The bottom end portion 26b is that portion of the front surface 16a which is close to the filter bottom side surface 16d.

The filter front surface 16a further has a left end portion 16c as one end of the filter 16 and a right end portion 16d as the other end of the filter 16. The left end portion 26c is that portion of the filter front surface 16a which is close to the filter left side surface 16e. The right end portion 26d is that portion of the filter front surface 16a which is close to the filter right side surface 16f.

Since the filter 16 is made of a transparent material, the display area 22 of the LCD 14 can be seen from outside the housing 10 through the opening 11 and the filter 16. An example of the filter 16 is a privacy filter. The privacy filter is a filter having a function of making the display area 22 of the LCD 14 viewable or not viewable from a prescribed angle when an on or off manipulation is performed through an input means such as the keyboard 5.

However, the filter 16 is not limited to a privacy filter and may be, for example, an electromagnetic wave shield filter or a filter for suppressing reflection of external light. The panel is not limited to a filter and maybe, for example, a tablet, that is, a touch panel for a tablet. Further, the panel may have any purpose and function and be of any kind as long as it is a plate-like, transparent member that is to be disposed in front of the LCD 14 and allows the display area 22 of the LCD 14 to be seen from outside the housing 10.

As shown in FIG. 3, the fixing members 17 include a top fixing member 17a as a first member and a bottom fixing member 17b as a second member. The fixing members 17 also include a left fixing member 17c as a first member and a right fixing member 17d as a second member.

The top fixing member 17a, the bottom fixing member 17b, the left fixing member 17c, and the right fixing member 17d are separate members. The bottom fixing member 17b will be described below in detail. As for the top fixing member 17a, the left fixing member 17c, and the right fixing member 17d, portions having the same functions as corresponding portions of the bottom fixing member 17b will be given the same reference symbols in the following and will not be described.

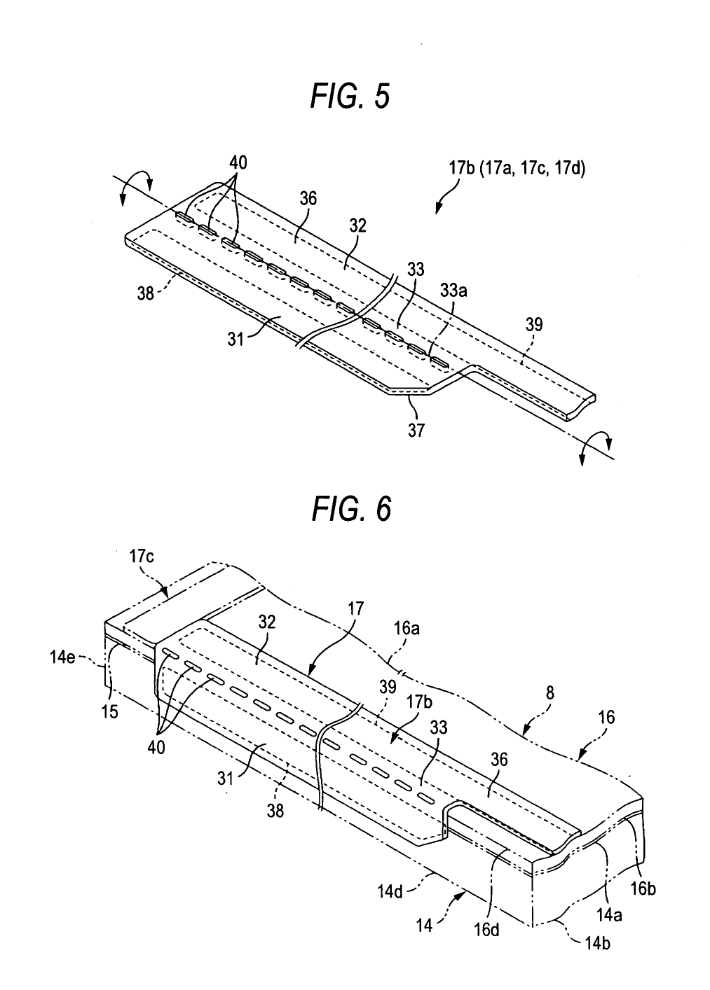

As shown in FIG. 5, the bottom fixing member 17b has a first portion 31 as one end, a second portion 32 as the other end, and a bending portion 33. The first portion 31 and the second portion 32 are arranged in the direction perpendicular to the longitudinal direction of the bottom fixing member 17b and extend in the longitudinal direction of the bottom fixing member 17b. The bending portion 33 is located between the first portion 31 and the second portion 32. The bottom fixing member 17b as a formed member assumes a sheet shape in which the first portion 31, the bending portion 33, and the second portion 32 are located in the same plane.

The bottom fixing member 17b has a top surface 36 as a first surface and a bottom surface 37 as a second surface. The first portion 31 has a first adhesive layer 38 on the bottom surface 37, and the second portion 32 has a second adhesive layer 39 on the bottom surface 37. The first and second adhesive surfaces 38 and 39 are double-sided adhesive tapes, for example.

The bending portion 33 has a bending line 33a which extends in the longitudinal direction of the bottom fixing member 17b. The bending portion 33 has plural slits 40 which are arranged along the bending line 33a and penetrate through the bottom fixing member 17b from its top surface 36 to its bottom surface 37.

As shown in FIG. 6, the bottom fixing member 17b is used in an L-shaped state obtained by bending the first portion 31 by 90° with respect to the second portion 32 along the bending line 33a of the bending portion 33.

As shown in FIG. 4, the L-shaped bottom fixing member 17b is attached to the LCD 14 and the filter 16 in such a manner that the top surface 36 of the bottom fixing member 17b is exposed inside the housing 10 and its bottom surface 37 faces the LCD 14 and the filter 16.

More specifically, the second portion 32 of the bottom fixing member 17b is disposed adjacent to the bottom end portion 26b of the filter front surface 16a and its first portion 31 is disposed adjacent to the bottom side surface 14d of the LCD 14. With this arrangement, the second portion 32 of the bottom fixing member 17b is bonded to the bottom end portion 26b of the filter front surface 16a via the second adhesive layer 39. And the first portion 31 of the bottom fixing member 17b is bonded to the bottom side surface 14d of the LCD 14 via the first adhesive layer 38. As a result, the filter 16 is fixed to the LCD 14.

As shown in FIG. 3, each of the top fixing member 17a, the left fixing member 17c, and the right fixing member 17d also has the first portion 31, the second portion 32, and the bending portion 33.

The second portion 32 of the top fixing member 17a is bonded to the top end portion 26a of the filter front surface 16a and its first portion 31 is bonded to the top side surface 14c of the LCD 14. The second portion 32 of the left fixing member 17c is bonded to the left end portion 26c of the filter front surface 16a and its first portion 31 is bonded to the left side surface 14e of the LCD 14. The second portion 32 of the right fixing member 17d is bonded to the right end portion 26d of the filter front surface 16a and its first portion 31 is bonded to the right side surface 14f of the LCD 14.

As shown in FIGS. 2 and 3, the left side surface 14e and the right side surface 14f of the LCD 14 have threaded holes 42 for fixing of the LCD 14 to the housing base 6. A cable 43 which is connected to a circuit board (not shown) for controlling the filter 16 extends from the filter bottom surface 16d. The bottom fixing member 17b, the left fixing member 17c, and the right fixing member 17d are cut so as to avoid the cable 43 and the threaded holes 42.

An example of the material of the fixing members 17 is a resin. However, the material of the fixing members 17 is not limited to a resin and may be rubber, for example. The material may also be sheet metal or the like that is bent into an L-shape in a stage of manufacture. As such, the material may be of any kind.

Next, a description will be made of how to assemble the portable computer 1.

At a start of assembling of the liquid crystal display module 8, the LCD 14 is prepared with its front surface 14a up. First, with the front surface 14a up, the spacers 15 are attached to the front surface 14a of the LCD 14. Then, the filter 16 is placed on the front surface 14a of the LCD 14 with the spacers 15 sandwiched between them.

In the state that the filter 16 is placed on the LCD 14, the top fixing member 17a, the bottom fixing member 17b, the left fixing member 17c, and the right fixing member 17d which are bent in an L-shape are sequentially bonded to the filter 16 and the LCD 14 and the filter 16 is thereby fixed to the LCD 14. The assembling of the liquid crystal display module 8 is thus completed.

At a start of assembling of the display unit 3, the integral assembly of the filter 16 and the LCD 14 is disposed in the housing 10. The position of the filter 16 is fixed when the LCD 14 is fixed to the housing 10 via the fixing members 7a and 7b.

On the other hand, in disassembling the display unit 3, the filter 16 and the LCD 14 can be taken out together as the liquid crystal display module 8 from inside the housing 10. Further, the filter 16 can easily be separated from the LCD 14 by peeling the fixing members 17 off the filter 16 and the LCD 14.

According to the portable computer 1 having the above configuration, the integral assembly of the filter 16 and the LCD 14 can be attached to and detached from the housing 10. In particular, since the fixing members 17 are attached to the filter 16 and the LCD 14 by gluing, the filter 16 can easily be fixed to the LCD 14 without using screws or other fixing members. This makes it possible to secure great ease of assembling and maintenance/replacement of the display unit 3.

Since the fixing members 17 are attached to the filter 16 and the LCD 14 by gluing, the fixing members 17 need not have a bracket-shaped cross section unlike in the conventional case. For example, as in this embodiment, the fixing members 17 having the L-shaped cross section can fix the filter 16 to the LCD 14. Therefore, unlike in the conventional case, complex work of inserting the filter 16 into a fixing member while deforming part of the fixing member is not necessary. The assembling of the display unit 3 according to the embodiment merely requires placing the filter 16 on the LCD 14 and then attaching the fixing members 17 to them from above. The work is simple and the ease of assembling of the display unit 3 is enhanced.

The fixing members 17 according to the embodiment include no fixing members behind the back surface 14b of the LCD 14. Therefore, the display unit 3 can be made thinner than a conventional display unit using a bracket-shaped holding member.

Since the fixing members 17 are given the L-shaped cross section and have the second portion 32 to be bonded to the filter front surface 16a, the total bonding area which cannot be made very wide only with the filter side surfaces 16c, 16d, 16e, and 16f can be made sufficiently wide. This makes it possible to fix the filter 16 to the LCD 14 reliably.

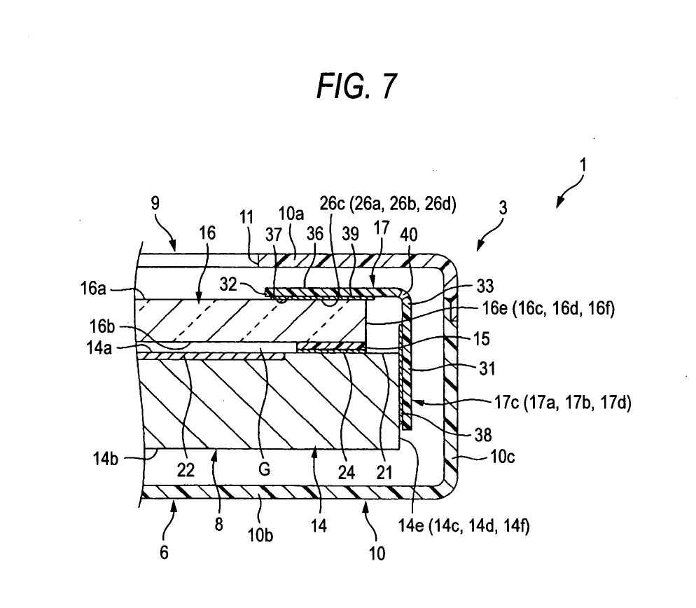

The fixing members 17 having the L-shaped cross section enables fixing, to the LCD 14, of, for example, a filter 16 that is narrower in the width direction than the LCD 14 as shown in FIG. 7. That is, the filter 16 need not be manufactured precisely so as to conform to the LCD 14, which makes it possible to reduce the manufacturing cost and shorten the manufacturing time.

Since the fixing members 17 are four separate fixing members 17a, 17b, 17c, and 17d, the filter 16 can be attached to the LCD 14 in a flexible manner. That is, a conventional frame-shaped fixing member in which four sides are integrated with each other can be attached to the LCD 14 only from above or below. In contrast, the fixing members 17a, 17b, 17c, and 17d according to the embodiment can be attached to the LCD 14 not only from above the filter 16 but also in horizontal directions or from obliquely above. The fixing members 17a, 17b, 17c, and 17d can thus be attached to the LCD 14 from directions that are suitable for a situation, which enhances the ease of assembling of the display unit 3.

If one or some of the fixing members 17a, 17b, 17c, and 17d are lowered in, adhesiveness, only those fixing members can be replaced. This enhances the ease of maintenance of the display unit 3. Further, forming the separate fixing members 17a, 17b, 17c, and 17d can make the material yield higher than in the case of an integral fixing member.

Interposing the spacers 15 between the filter 16 and the LCD 14 makes it possible to secure the gap G between the filter 16 and the LCD 14. And the gap G prevents the surfaces of the filter 16 and the LCD 14 from contacting each other even when the filter 16 and the LCD 14 is bent, warped, or deformed otherwise.

In particular, forming the spacers 15 separately from the fixing members 17 as in the embodiment makes it possible to independently perform an operation of attaching the spacers 15 to the LCD 14 and an operation of fixing the filter 16 to the LCD 14 using the fixing members 17, which can enhance the ease of assembling and maintenance/replacement of the display unit 3.

Forming the fixing members 17a, 17b, 17c, and 17d into a sheet shape facilitates their manufacture and reduce their manufacturing cost.

Since the bending portion 33 has the slits 40, the fixing members 17a, 17b, 17c, and 17d can be bent easily, which enhances the ease of work. In addition, the slits 40 also serve as grounding means which, when such a thing as a human hand that is charged with static electricity touches one of the fixing members 17, lead the static electricity to outside the liquid crystal display module 8 via the LCD 14.

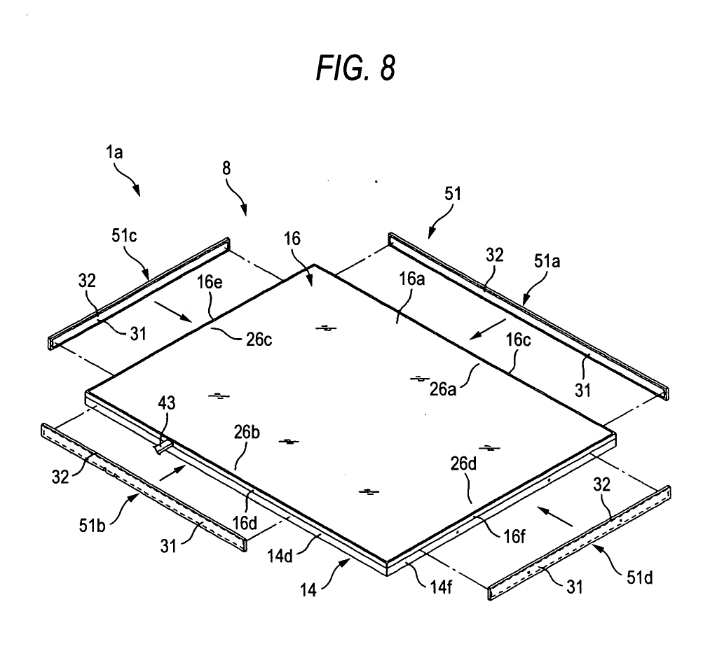

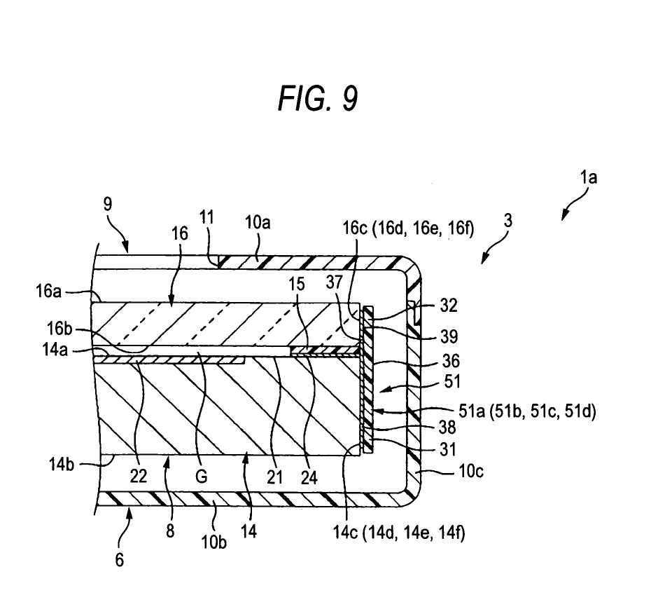

Next, a portable computer la as an electronic apparatus according to a second embodiment of the invention will be described with reference to FIGS. 8 and 9. Components having the same functions as corresponding components of the portable computer 1 according to the first embodiment will be given the same reference symbols in the following and will not be described.

A liquid crystal display module 8 of the portable computer la has fixing members 51. As shown in FIG. 8, the fixing members 51 include a top fixing member 51a as a first member and a bottom fixing member 51b as a second member. The fixing members 51 also include a left fixing member 51c as a first member and a right fixing member 51d as a second member. The top fixing member 51a, the bottom fixing member 51b, the left fixing member 51c, and the right fixing member 51d are separate members.

As shown in FIG. 9, each of the fixing members 51a, 51b, 51c, and 51d has a first portion 31 as one end and a second portion 32 as the other end and assumes a sheet shape in which the first portion 31 and the second portion 32 are located in the same plane.

The sheet-shaped fixing members 51a, 51b, 51c, and 51d are arranged in such a manner that the second portions 32 are disposed adjacent to the respective filter side surfaces 16c, 16d, 16e, and 16f and the first portions 31 are disposed adjacent to the respective side surfaces 14c, 14d, 14e, and 14f of the LCD 14.

With the above arrangement, the second portion 32 of the top fixing member 51a is bonded to the filter top side surface 16c as one end of the filter 16 and its first portion 31 is bonded to the top side surface 14c of the LCD 14. The second portion 32 of the bottom fixing member 51b is bonded to the filter bottom side surface 16d as the other end of the filter 16 and its first portion 31 is bonded to the bottom side surface 14d of the LCD 14.

The second portion 32 of the left fixing member 51c is bonded to the filter left side surface 16e as one end of the filter 16 and its first portion 31 is bonded to the left side surface 14e of the LCD 14. The second portion 32 of the right fixing member 51d is bonded to the filter right side surface 16f as the other end of the filter 16 and its first portion 31 is bonded to the right side surface 14f of the LCD 14.

Also in the portable computer la having the above configuration, great ease of assembling and maintenance/replacement of the display unit 3 can be secured because the fixing members 51 are attached to the filter 16 the LCD 14 by gluing. Further, since gluing is employed as an attaching method, the filter 16 can be fixed to the LCD 14 even with the sheet-shaped fixing members 51.

The assembling of the display unit 3 according to the embodiment merely requires placing the filter 16 on the LCD 14 and then attaching the fixing members 51a, 51b, 51c, and 51d to them sequentially in horizontal directions. The work is simple and the ease of assembling of the display unit 3 is enhanced. The fixing members 51 according to this embodiment include no fixing members to be placed on the front surface 14a or the back surface 14b of the LCD 14, which makes it possible to thin the display unit 3.

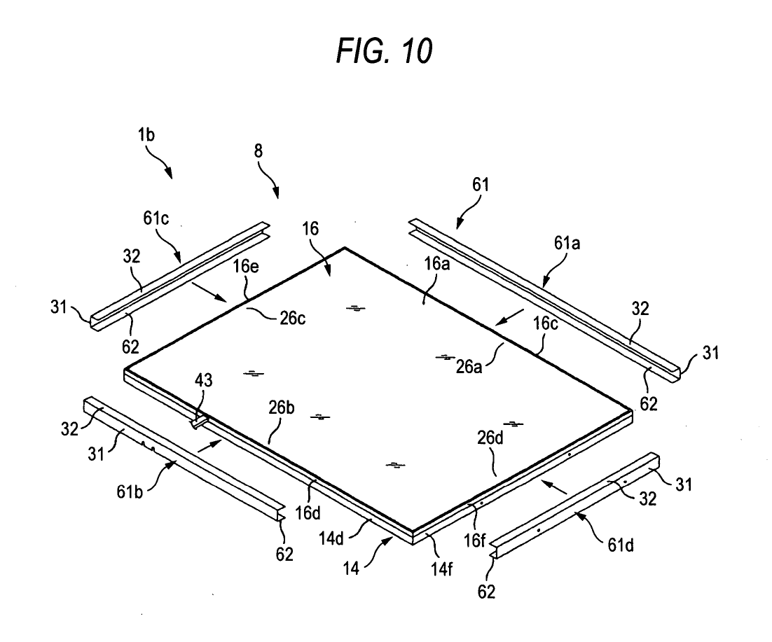

Next, a portable computer 1b as an electronic apparatus according to a third embodiment of the invention will be described with reference to FIGS. 10 to 12. Components having the same functions as corresponding components of the portable computer 1 according to the first embodiment will be given the same reference symbols in the following and will not be described.

A liquid crystal display module 8 of the portable computer 1b has fixing members 61. As shown in FIG. 10, the fixing members 61 include a top fixing member 61a as a first member and a bottom fixing member 61b as a second member. The fixing members 61 also include a left fixing member 61c as a first member and a right fixing member 61d as a second member. The top fixing member 61a, the bottom fixing member 61b, the left fixing member 61c, and the right fixing member 61d are separate members.

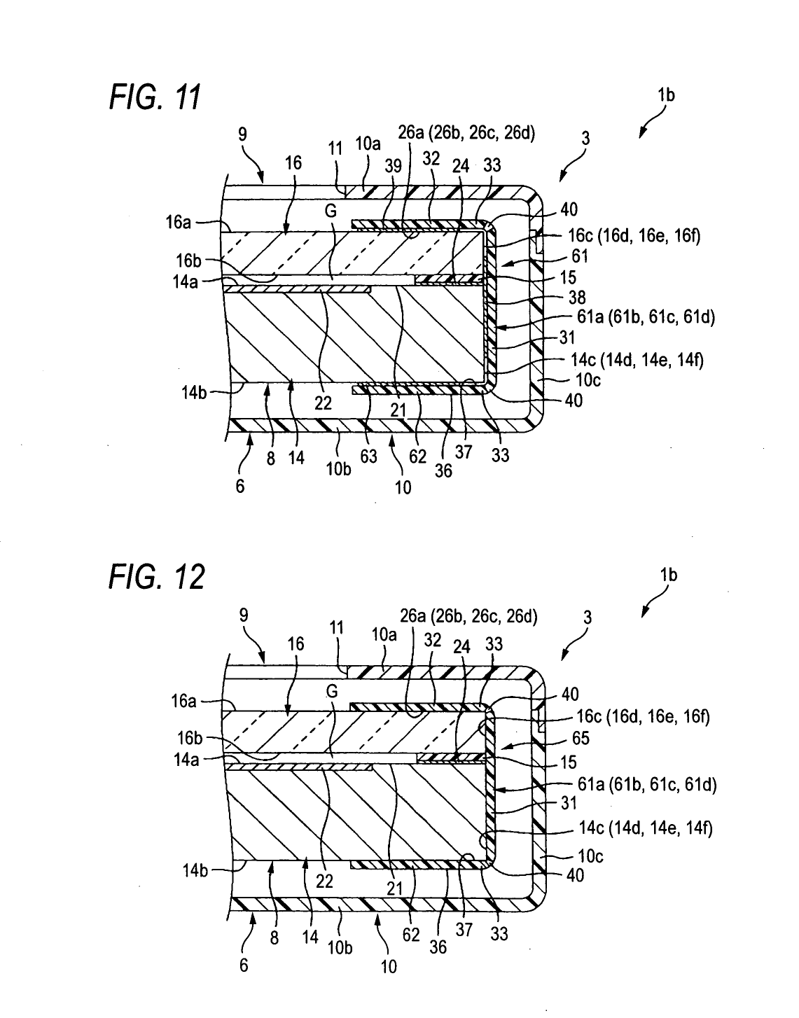

As shown in FIG. 11, each of the fixing members 61a, 61b, 61c, and 61d has a first portion 31 as one end, a third portion 62, and a second portion 32 as the other end. The second portion 32 is bent by 90° with respect to the first portion 31. The third portion 62 is bent by 90° with respect to the first portion 31. That is, each of the fixing members 61a, 61b, 61c, and 61d has a bracket-shaped cross section. The third portion 62 has a third adhesive layer 63 on a bottom surface 37.

The sheet-shaped fixing members 61a, 61b, 61c, and 61d are arranged in such a manner that the second portions 32 are disposed adjacent to the respective end portions 26a, 26b, 26c, and 26d of the filter front surface 16a, the first portions 31 are disposed adjacent to the respective side surfaces 14c, 14d, 14e, and 14f of the LCD 14, and the third portions 62 are disposed adjacent to the back surface 14b of the LCD 14.

With the above arrangement, the second portion 32 of the top fixing member 61a is bonded to the top end portion 26a of the filter front surface 16a, its first portion 31 is bonded to the top side surface 14c of the LCD 14, and its third portion 62 is bonded to the back surface 14b of the LCD 14. The second portion 32 of the bottom fixing member 61b is bonded to the bottom end portion 26b of the filter front surface 16a, its first portion 31 is bonded to the bottom side surface 14d of the LCD 14, and its third portion 62 is bonded to the back surface 14b of the LCD 14.

The second portion 32 of the left fixing member 61c is bonded to the left end portion 26c of the filter front surface 16a, its first portion 31 is bonded to the left side surface 14e of the LCD 14, and its third portion 62 is bonded to the back surface 14b of the LCD 14. The second portion 32 of the right fixing member 61d is bonded to the right end portion 26d of the filter front surface 16a, its first portion 31 is bonded to the right side surface 14f of the LCD 14, and its third portion 62 is bonded to the back surface 14b of the LCD 14.

Also in the portable computer 1b having the above configuration, the ease of assembling and maintenance/replacement of the display unit 3 can be enhanced because the fixing members 61 are the four separate fixing members 61a, 61b, 61c, and 61d. Therefore, unlike in the conventional case, complex work of inserting the filter 16 into a fixing member while deforming part of the fixing member is not necessary. The assembling of the display unit 3 according to the embodiment merely requires placing the filter 16 on the LCD 14 and then attaching the fixing members 61a, 61b, 61c, and 61d to them in horizontal directions. The work is simple and the ease of assembling of the display unit 3 is enhanced.

Forming the fixing members 61 into a bracket-shape as in the embodiment makes it possible to fix the filter 16 to the LCD 14 even with fixing members 65 not having the first to third adhesive layers 38, 39, and 63. That is, as shown in FIG. 12, the filter 16 can be fixed to the LCD 14 by fitting the fixing members 65 with the filter 16 and the LCD 14.

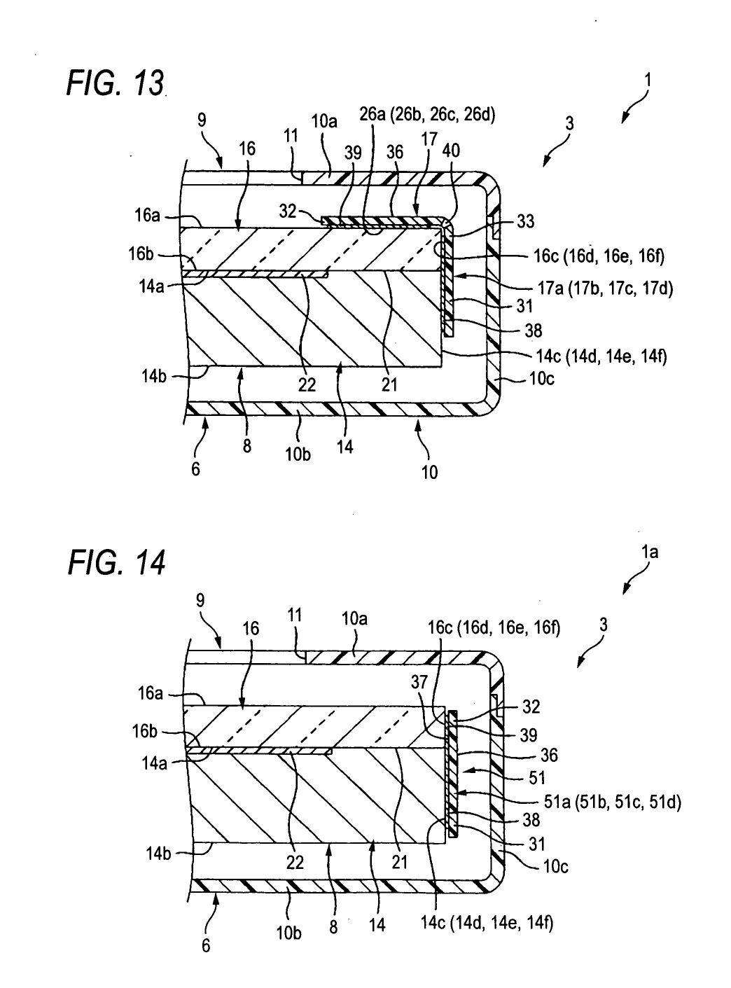

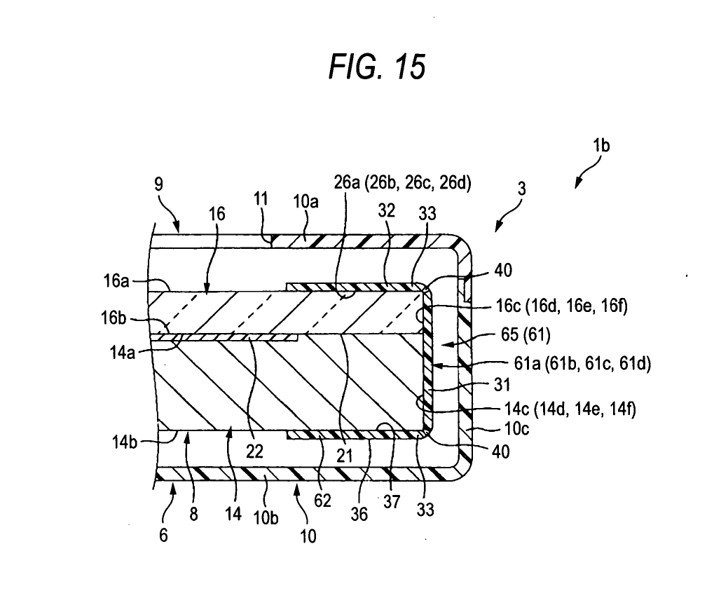

The first to third embodiments have been described above. However, where the filter back surface 16b and the front surface 14a of the LCD 14 are smoothed by taking a proper measure, as shown in FIGS. 13 to 15 the spacers 15 may be omitted by bringing the filter 16 and the LCD 14 into contact with each other.

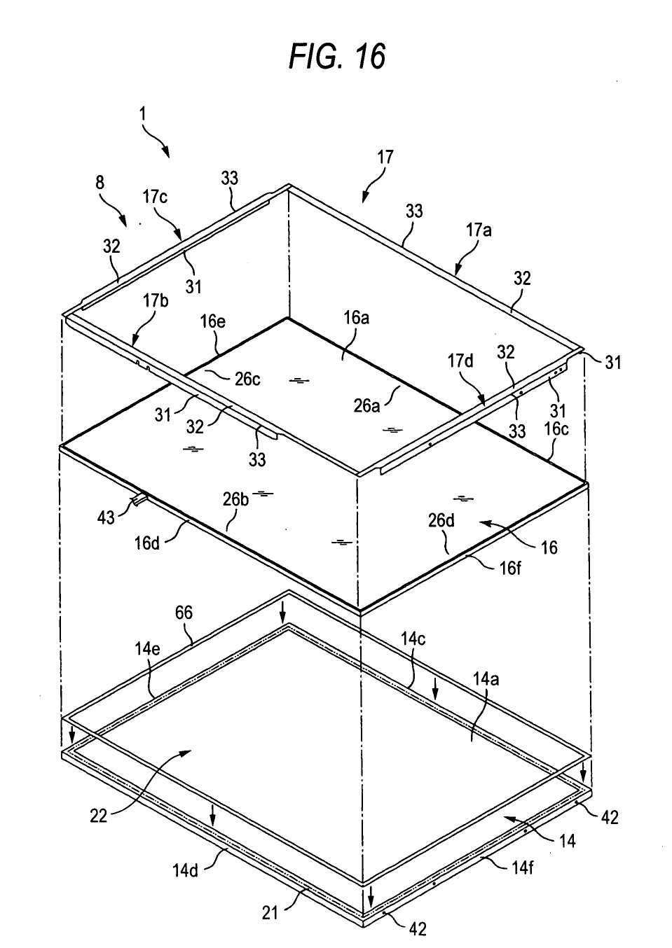

There are no particular limitations on the number of spacers 15 and the positions and ranges where the spacers 15 are attached. For example, as shown in FIG. 16, a spacer 66 may be used which is shaped like a frame so as to surround the display area 22 of the LCD 14.

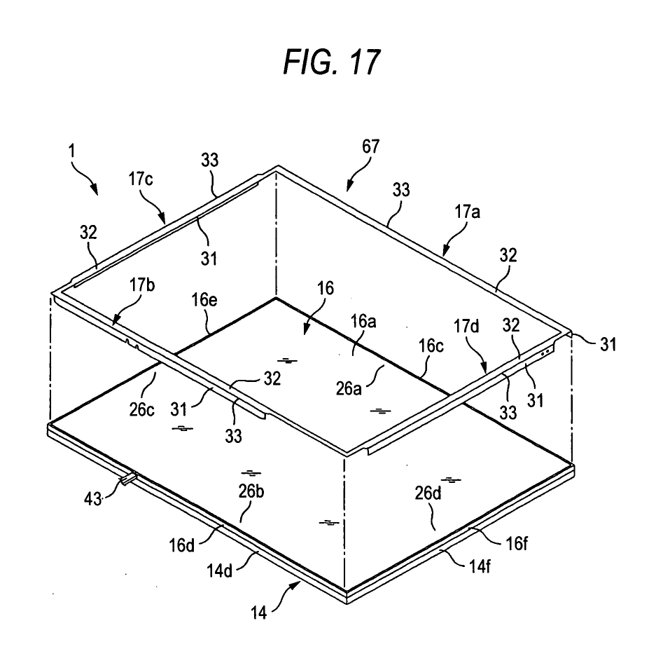

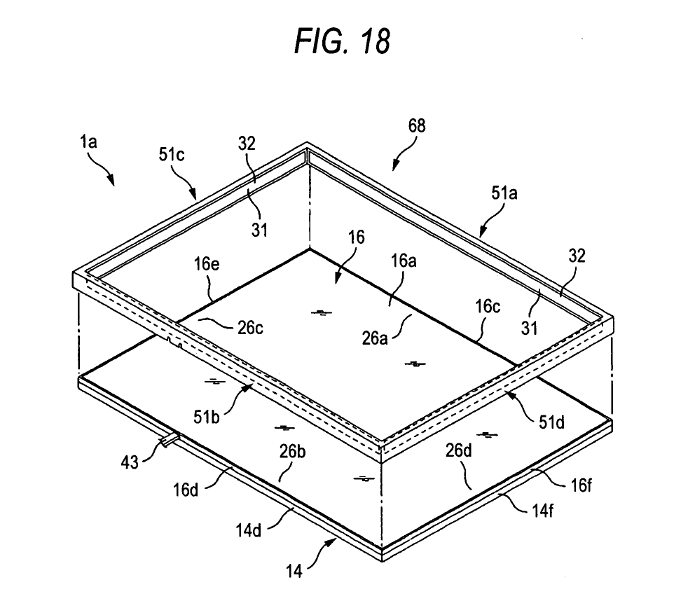

As shown in FIG. 17, a fixing member 67 may be used which is formed by integrating the four fixing members 17a, 17b, 17c, and 17d. Further, as shown in FIG. 18, a fixing member 68 may be used which is formed by integrating the four fixing members 51a, 51b, 51c, and 51d. Where the fixing member 67 or 68 is used, the degree of ease of assembling of the display unit 3 is lower than in the first or second embodiment.

However, the fixing member 67 has an L-shaped cross section and the fixing member 68 assumes a sheet shape. Therefore, even with the fixing member 67 or 68, unlike in the conventional case, complex work of inserting the filter 16 into a fixing member while deforming part of the fixing member is not necessary. The assembling of the display unit 3 merely requires placing the filter 16 on the LCD 14 and then attaching the fixing member 67 or 68 to them from above. The work is simple and the ease of assembling of the display unit 3 is enhanced.

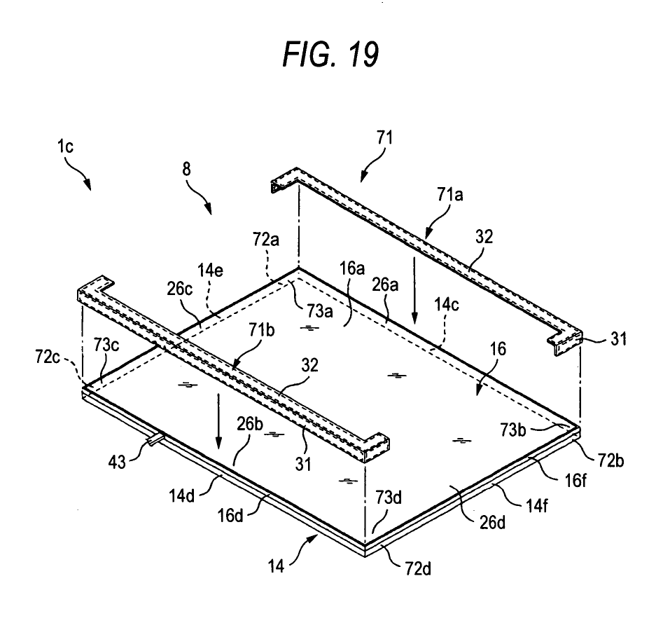

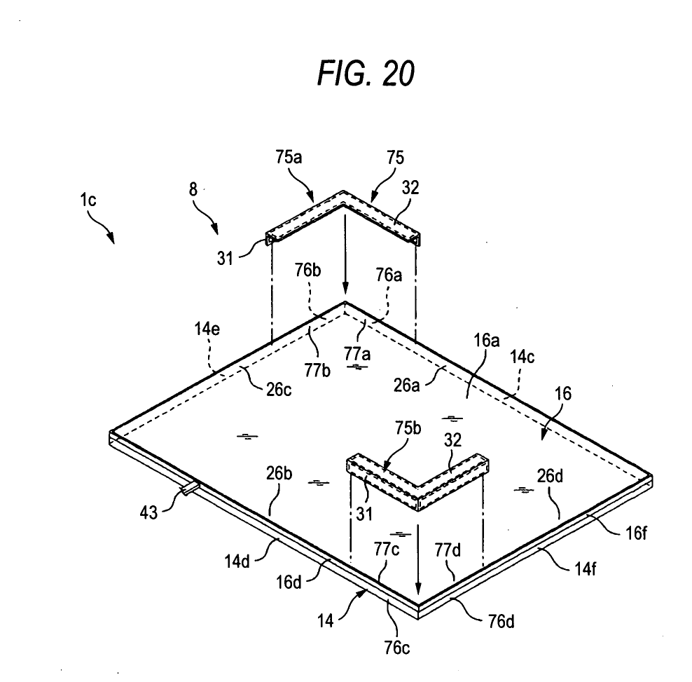

Next, a portable computer 1c as an electronic apparatus according to a fourth embodiment of the invention will be described with reference to FIGS. 19 and 20. Components having the same functions as corresponding components of the portable computer 1 according to the first embodiment will be given the same reference symbols in the following and will not be described.

A liquid crystal display module 8 of the portable computer 1c has fixing members 71. As shown in FIG. 19, the fixing members 71 include a first fixing member 71a as a first member and a second fixing member 71b as a second member.

The first fixing member 71a has a first portion 31 and a second portion 32. The first portion 31 of the first fixing member 71a is formed so as to cover the entire top side surface 14c, a top end portion 72a of the left side surface 14e, and a top end portion 72b of the right side surface 14f of the LCD 14. The second portion 32 of the first fixing member 71a is formed so as to cover the entire top end portion 26a, a top end portion 73a of the left end portion 26c, and a top end portion 73b of the right end portion 26d of the filter front surface 16a.

The second fixing member 71b has a first portion 31 and a second portion 32. The first portion 31 of the second fixing member 71b is formed so as to cover the entire bottom side surface 14d, a bottom end portion 72c of the left side surface 14e, and a bottom end portion 72d of the right side surface 14f of the LCD 14. The second portion 32 of the second fixing member 71b is formed so as to cover the entire bottom end portion 26b, a bottom end portion 73c of the left end portion 26c, and a bottom end portion 73d of the right end portion 26d of the filter front surface 16a.

The top end portion and the bottom end portion of the filter 16 are fixed to the LCD 14 by the first and second fixing members 71a and 71b, respectively. On the other hand, most of each of the left end portion and the right end portion of the filter 16 is not fixed to the LCD 14 directly.

However, parts of the left end portion and the right end portion of the filter 16 are held by the first and second fixing members 71a and 71b, respectively. As a result, the filter left side surface 16e and the filter right side surface 16f are rendered flush with the left side surface 14e and the right side surface 14f of the LCD 14, respectively. Therefore, the filter 16 is attached to the LCD 14 in such a state as to be in registration with the LCD 14.

According to the portable computer 1c having the above configuration, since the fixing members 71 are attached to the filter 16 and the LCD 14 by gluing, great ease of assembling and maintenance/replacement of the display unit 3 can also be secured.

In particular, the fixing members 71 are the two fixing members, that is, the first fixing member 71a and the second fixing member 71b. Therefore, the time and labor that are required for the attachment of the fixing members 71 are less than those required for the attachment of the fixing members 17, 51, or 61 according to the first, second, or third embodiment, for example. This contributes to the enhancement of the ease of assembling of the display unit 3.

FIG. 20 shows fixing members 75 which are two fixing members as in the case of FIG. 19. The fixing members 75 are a first fixing member 75a as a first member and a second fixing member 75b as a second member.

A first portion 31 of the first fixing member 75a is formed so as to cover a left portion 76a of the top side surface 14c and a top portion 76b of the left side surface 14e of the LCD 14. A second portion 32 of the first fixing member 75a is formed so as to cover a left portion 77a of the top end portion 26a and a top portion 77b of the left end portion 26c of the filter front surface 16a.

A first portion 31 of the second fixing member 75b is formed so as to cover a right portion 76c of the bottom side surface 14d and a bottom portion 76d of the right side surface 14f of the LCD 14. A second portion 32 of the second fixing member 75b is formed so as to cover a right portion 77c of the bottom end portion 26b and a bottom portion 77d of the right end portion 26d of the filter front surface 16a.

The use of the fixing members 75 can provide the same advantages as obtained by using the fixing members 71.

Where a separate measure is taken to render the side surfaces 16c, 16d, 16e, and 16f of the filter 16 flush with the respective side surfaces 14c, 14d, 14e, and 14f of the LCD 14, the filter 16 can be attached to the LCD 14 with two fixing members that are different from the fixing members 71 or 75 according to the embodiment, such as the top fixing member 17a and the bottom fixing member 17b according to the first embodiment.

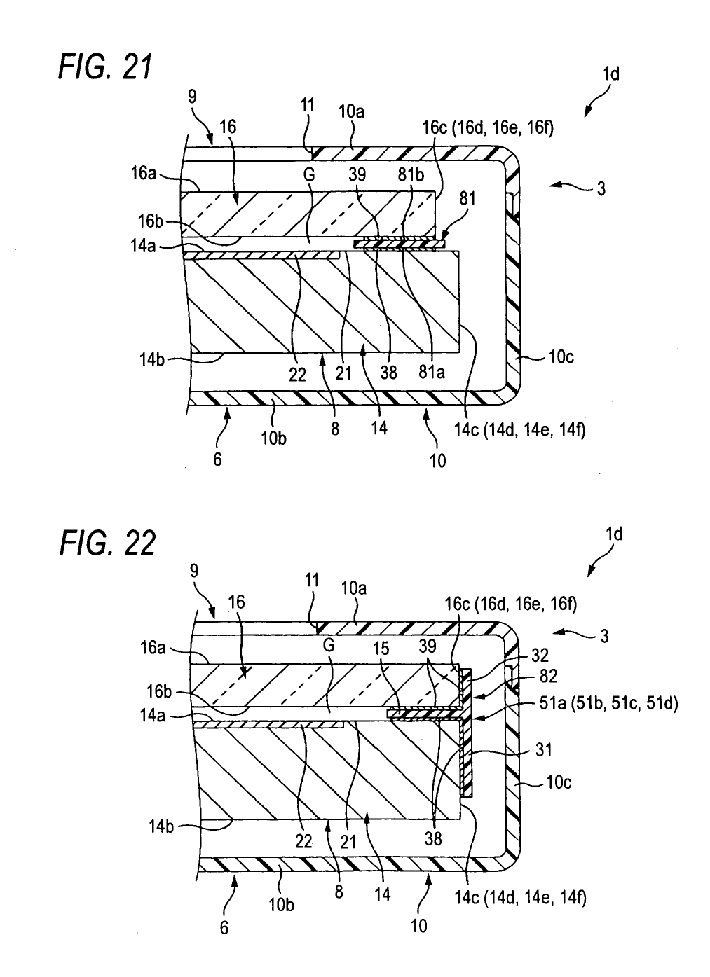

Next, a portable computer id as an electronic apparatus according to a fifth embodiment of the invention will be described with reference to FIGS. 21 and 22. Components having the same functions as corresponding components of the portable computer is 1 or 1a according to the first or second embodiment will be given the same reference symbols in the following and will not be described.

A liquid crystal display module 8 of the portable computer 1d has a fixing member 81. As shown in FIG. 21, the fixing member 81 is sandwiched between the filter back surface 16b and the front surface 14a of the LCD 14 and thereby forms a gap G between the LCD 14 and the filter 16. That is, the fixing member 81 also serves as a spacer 15.

The fixing member 81 has a bottom surface 81a as one end and a top surface 81b as the other end. The bottom surface 81a is opposed to the front surface 14a of the LCD 14. The bottom surface 81a has a first adhesive layer 38, and is bonded to the front surface 14a of the LCD 14 via the first adhesive layer 38. The top surface 81b is opposed to the filter back surface 16b. The top surface 81b has a second adhesive layer 39, and is bonded to the filter back surface 16b via the second adhesive layer 39. In this manner, the filter 16 is fixed to the LCD 14.

According to the portable computer 1d having the above configuration, since the fixing member 81 is attached to the filter 16 and the LCD 14 by gluing, great ease of assembling and maintenance/replacement of the display unit 3 can also be secured. Since the fixing member 81 functions as the spacer 15, the ease of assembling and maintenance/replacement of the display unit 3 can be enhanced without the need for attaching a dedicated spacer. Further, the fixing member 81 according to the embodiment include no fixing members on the filter front surface 16a or the back surface 14b of the LCD 14, and hence the display unit 3 can be thinned accordingly.

As for the shape of the fixing member 81, plural, separate fixing members 81 may be disposed on the front surface 14a of the LCD 14 in a distributed manner like the spacers 15 shown in FIG. 3. Alternatively, the fixing member 81 may be shaped like a frame so as to surround the display area 22 of the LCD 14, like the spacer 66 shown in FIG. 16.

Alternatively, as shown in FIG. 22, a fixing member 82 may be used which is an integral member of the fixing members 51 according to the second embodiment and the spacer 15. The use of the fixing member 82 makes it possible to omit an operation of attaching the spacer separately from the fixing member 82 and thereby enhance the ease of assembling and maintenance/replacement of the display unit 3.

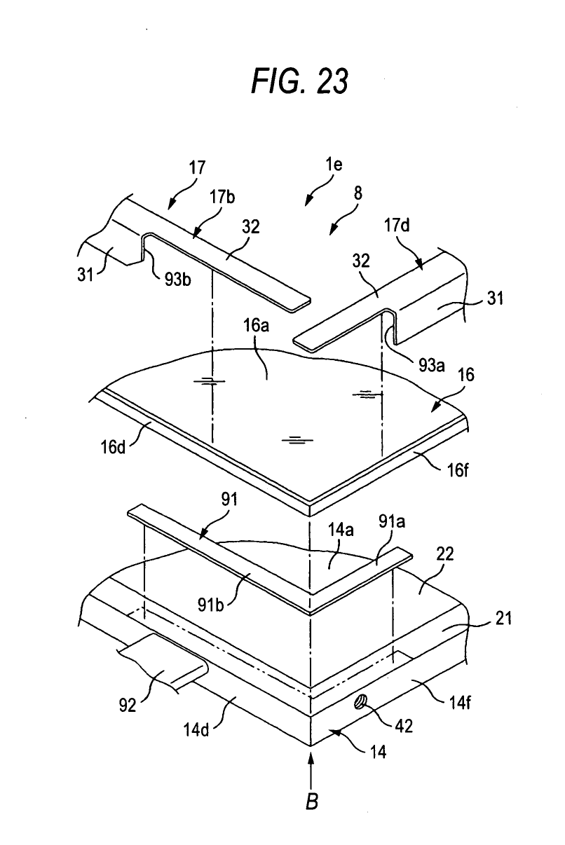

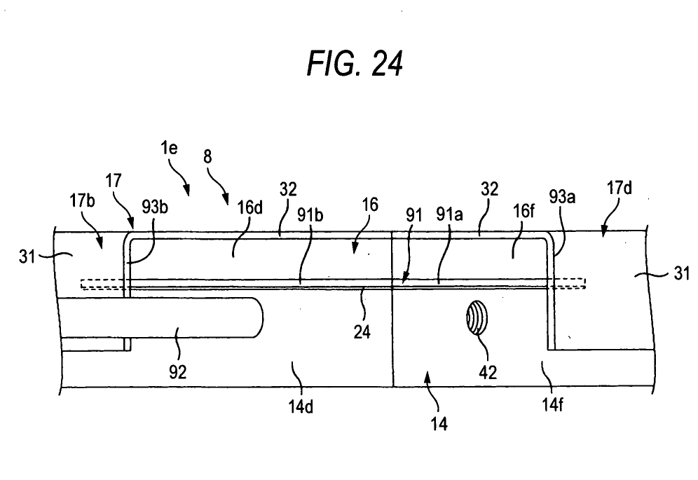

Next, a portable computer 1e as an electronic apparatus according to a sixth embodiment of the invention will be described with reference to FIGS. 23 and 24. Components having the same functions as corresponding components of the portable computer 1 according to the first embodiment will be given the same reference symbols in the following and will not be described.

A liquid crystal display module 8 of the portable computer 1e has a spacer 91. As shown in FIG. 23, the spacer 91 is attached to a bottom-right corner portion of the front surface 14a of the LCD 14. The spacer 91 has a first member 91a extending toward the top side surface 14c of the LCD 14 and a second member 91b extending toward the left side surface 14e of the LCD 14.

On the other hand, the right fixing member 17d as one fixing member 17 has a first cut 93a which is formed so as to avoid a threaded hole 42 that is formed in the right side surface 14f of the LCD 14. And the bottom fixing member 17b as another fixing member 17 has a second cut 93b which is formed so as to avoid a cable 92 that extends outward from the bottom side surface 14d of the LCD 14.

The first member 91a of the spacer 91 is longer than the longitudinal length of the first cut 93a. And the second member 91b of the spacer 91 is longer than the longitudinal length of the second cut 93b. The liquid crystal display module 8 also has spacers 91 which are attached to respective corner portions of the front surface 14a of the LCD 14 other than the bottom-right corner portion and are shaped so as to conform to the respective corner portions.

The portable computer 1e having the above configuration can also secure great ease of assembling and maintenance/replacement of the display unit 3.

In particular, where the spacers 91 according to the embodiment are employed, as shown in FIG. 24 the side surfaces of the liquid crystal display module 8 is sealed completely. Originally, a liquid crystal display module 8 has a gap G between the LCD 14 and the filter 16. Since the gap G communicates with the outside of the liquid crystal display module 8, foreign substances such as dust enter the liquid crystal display module 8 through the gap G.

In contrast, in the liquid crystal display module 8 according to the embodiment, most of each opening of the gap G in the side surfaces of the liquid crystal display module 8 is closed by the associated fixing member 17. Further, the corner portions of the liquid crystal display module 8 that are not closed by the fixing members 17 are closed by the spacers 91. Therefore, foreign substances can be prevented from entering the liquid crystal display module 8.

The portable computers 1, 1a, 1b, 1c, 1d, and 1e according to the first to sixth embodiments have been described above. However, it goes without saying that the invention is not limited to those. The invention can also be applied to any electronic apparatus in which a panel such as a filter or a tablet is disposed in front of a display. For example, the invention can be applied to such electronic apparatus as cell phones and liquid crystal and plasma TV receivers.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus comprising:
a housing including a wall having an opening;
a display which is disposed in the housing, opposed to the opening, and having a screen;
a panel having a transparency and disposed in the housing between the opening and the screen of the display; and
a fixing member which fixes the panel to the display, one end of the fixing member being bonded to the display and the other end of the fixing member being bonded to the panel.

2. The electronic apparatus according to claim 1, wherein
the panel has a panel surface which is opposed to the screen of the display, and
a spacer is sandwiched between the screen of the display and the panel surface.

3. The electronic apparatus according to claim 1, wherein
the display has a side surface which extends from a circumference of the screen toward a side opposite to the wall of the housing,
the panel has a panel side surface which extends from a circumference of the panel surface toward the side opposite to the wall of the housing, and
one end of the fixing member is bonded to the side surface of the display and the other end of the fixing member is bonded to the panel side surface.

4. The electronic apparatus according to claim 1, wherein
the display has a side surface which extends from a circumference of the screen toward a side opposite to the wall of the housing,
the panel has an other panel surface which is opposed to the opening, and
one end of the fixing member is bonded to the side surface of the display and the other end of the fixing member is bonded to the other panel surface.

5. An electronic apparatus comprising:
a housing including a wall having an opening;
a display which is disposed in the housing, opposed to the opening, and having a screen;
a panel having a transparency and disposed in the housing between the opening and the screen of the display; and
fixing members which fixes the panel to the display, the fixing members including a first member which fixes one end of the panel to the display and a second member which is formed separately from the first member and fixes the other end of the panel to the display.

6. The electronic apparatus according to claim 5, wherein
one end of each of the first member and the second member is bonded to the display and the other end of each of the first member and the second member is bonded to the panel.

7. The electronic apparatus according to claim 6, wherein
the panel has a panel surface which is opposed to the screen of the display, and
a spacer is sandwiched between the screen of the display and the panel surface.

8. The electronic apparatus according to claim 6, wherein
the display has a side surface which extends from a circumference of the screen toward a side opposite to the wall of the housing,
the panel has a panel side surface which extends from a circumference of the panel surface toward the side opposite to the wall of the housing, and
one end of the fixing member is bonded to the side surface of the display and the other end of the fixing member is bonded to the panel side surface.

9. The electronic apparatus according to claim 6, wherein
the display has a side surface which extends from a circumference of the screen toward a side opposite to the wall of the housing,
the panel has an other panel surface which is opposed to the opening, and
one end of the fixing member is bonded to the side surface of the display and the other end of the fixing member is bonded to the other panel surface.

10. The electronic apparatus according to claim 9, wherein
the fixing member has a bending portion between the one end which is bonded to the display and the other end which is bonded to the panel,
the fixing member is formed into a sheet shape in which the one end, the bending portion, and the other end are located in the same plane, and
the fixing member is used in a state that the one end is bent by a prescribed angle with respect to the other end along the bending portion.

11. The electronic apparatus according to claim 10, wherein
the fixing member has a first surface which is exposed to an inside of the housing and a second surface which faces the display or the panel, and
the bending portion has a slit which is arranged along a bending line and penetrates from the first surface to the second surface.

12. The electronic apparatus according to claim 6, wherein
the display has a side surface which extends from a circumference of the screen toward a side opposite to the wall of the housing,
the panel has a panel side surface which extends from a circumference of the panel surface toward the side opposite to the wall of the housing, and
one end of the fixing member is bonded to the side surface of the display and the other end of the fixing member is bonded to the panel side surface.

13. The electronic apparatus according to claim 6, wherein
the display has a side surface which extends from a circumference of the screen toward a side opposite to the wall of the housing,
the panel has an other panel surface which is opposed to the opening, and
one end of the fixing member is bonded to the side surface of the display and the other end of the fixing member is bonded to the other panel surface.

14. The electronic apparatus according to claim 13, wherein
the fixing member has a bending portion between the one end which is bonded to the display and the other end which is bonded to the panel,
the fixing member is formed into a sheet shape in which the one end, the bending portion, and the other end are located in the same plane, and
the fixing member is used in a state that the one end is bent by a prescribed angle with respect to the other end along the bending portion.

15. The electronic apparatus according to claim 14, wherein
the fixing member has a first surface which is exposed to an inside of the housing and a second surface which faces the display or the panel, and
the bending portion has a slit which is arranged along a bending line and penetrates from the first surface to the second surface.

16. The electronic apparatus according to claim 1, wherein
the panel has a panel surface which is opposed to the screen of the display, and
the fixing member is sandwiched between the screen of the display and the panel surface, thereby forming a gap between the display and the panel.
